(19) United States
(12) Patent Application Publication
(10) Pub. No.: US 2016/0272231 A1
(43) Pub. Date: Sep. 22, 2016

(54) SUPPORTING STRUCTURE, PLAYER AND MOBILE DEVICE USING THE SAME

(71) Applicant: CHIGOO INTERACTIVE TECHNOLOGY CO., LTD., Wuxi, Jiangsu (CN)

(72) Inventors: Tao Chen, Wuxi (CN); Chuanrong Pan, Wuxi (CN); Weijian Lan, Wuxi (CN); Hua Zhou, Wuxi (CN); Yong Yang, Wuxi (CN); Rong Han, Wuxi (CN)

(73) Assignee: CHIGOO INTERACTIVE TECHNOLOGY CO., LTD., Wuxi, Jiangsu (CN)

(21) Appl. No.: 15/029,412

(22) PCT Filed: Aug. 26, 2014
(86) PCT No.: PCT/CN2014/085176

§ 371 Date: Apr. 14, 2016

(30) Foreign Application Priority Data
Oct. 16, 2013 (CN) 201320640581.6

(51) Int. Cl. B62B 3/14

(52) U.S. Cl. CPC B62B 3/1416; B62B 2202/56

(57) ABSTRACT

A supporting structure includes a support body, stationary shafts and stoppers disposed at opposite ends of the support body coaxially with the stationary shafts. Each of the stationary shafts is provided with an arc-shaped notch matching with the stoppers circumferentially so that the stoppers are rotatable about the stationary shafts along the arc-shaped notch, thereby allowing an installing angle of the supported member on a movable device, such as trolleys, to be set and adjusted, so as to satisfy different needs of users for the orientation of the supported member. Also provided is a multimedia player employing the supporting structure and a movable device employing the player.

### TECHNICAL FIELD

The present invention relates to a supporting structure, in particular to a supporting structure being capable of adjusting angles of a supported article, a player employing the supporting structure and a mobile device employing the player.

### BACKGROUND OF ART

Air travel has become more and more common. Since airport area is too large, passengers may have to ask for directions several times before reaching a registration desk. In this case, a trolley with a multimedia player for broadcasting and guiding emerges, which provides convenience for users. However, various problems may arise when passengers use the trolley, For example, some passengers may use the player as a temporary dining-table for a momentary convenience and put drink and foods on the surface of the player's display screen, and some passengers may use the player as a child seat to allow children sitting on the player. In addition, since overall assembling process and technology of a trolley's frame are not yet perfect, a stress is easily to generate in the interior of the frame. This stress exists for long, which may undermine the overall structure of the player. Such phenomenon is likely to cause damage to the trolley's player, and may have a safety problem.

### SUMMARY OF THE INVENTION

An object of the present invention is to provide a supporting structure capable of adjusting angles of a supported member. The supporting structure comprises a support body, stationary shafts and stoppers disposed at opposite ends of said support body and being coaxial with the stationary shafts, wherein each of said stationary shafts is provided with an arc-shaped notch matching with each of the stoppers circumferentially, so that the stoppers are rotatable about the stationary shafts along the arc-shaped notch, which causes the supported body to rotate about the stationary shaft, thereby allowing an installing angle of the supported body on a mobile device, such as trolleys, etc., to be set and adjusted to meet different needs of users for angles of the supported member.

In some embodiments, the stopper comprises a stopper body and a stopper projection provided on an inner wall of the stopper body. The stoppers can rotate stably along the stationary shafts through cooperation of the stopper bodies and the stationary shafts.

In some embodiments, the stopper body is U-shaped. The U-shaped stopper body can facilitate a rotation of the stopper about the stationary shaft. Meanwhile, the bottom of the U-shaped stopper body can prevent foreign material from entering into the arc-shaped notch, and thus effectively avoid failure of the stopper's rotation about the stationary shafts due to entering of the foreign material into the arc-shaped notch.

In some embodiments, the fixed shaft comprises a shaft base and a shaft portion in a T-shaped connection with the shaft base, the arc-shaped notch is provided at an end of the shaft portion connected to the stationary shaft base. Thus, the stoppers and the stationary shafts are integrated through the cooperation with each other, allowing a steady rotation of the supporting structure and enhancement of an entire strength of the same.

In some embodiments, the shaft base and the shaft portion have a hollow structure, which reduces the weight of the supporting structure and saves makings.

In some embodiments, a central angle of the arc-shaped notch is an acute angle. Thus, the supported member may rotate about the stationary shafts within an acute angel range after installed on the supporting structure, so as to satisfy different needs of users for the orientation of the supported member.

In some embodiments, the outer diameter of the shaft portion is smaller than the inner diameter of an arc portion at the bottom of the stopper body. This may reduce the wear therebetween when the stoppers rotate about the stationary shafts, which causes the rotation of the stoppers more efficiently.

In some embodiments, support plates are disposed on the support body, and an end of the support plate is inserted into the interior of the stationary shafts. After the support body is installed on a movable device, it can prevent the internal structure of the support body from being damaged due to the internal stress of the movable device, which increases the strength of the support body and protect the same. Meanwhile, deformation of the mobile device due to its internal stress can be avoided.

In a further aspect, a player is provided which comprises a player member and a supporting structure mentioned above. The player member comprises a multimedia player device and is disposed in the support body. Thus, the player member can rotate about the stationary shafts along with the stoppers, which provides convenience to users.

According to a further aspect of the invention, there is provided a movable device which comprises a movable device body and a player mentioned above, stationary shafts of the supporting structure of the player are disposed on the movable device body. The player according to the invention can rotate about the stationary shafts so as to prevent the player from being damaged due to the improper use of users when the player can only be disposed horizontally, and meet different needs of users for the orientation of the player.

### BRIEF DESCRIPTION OF THE DRAWINGS

FIG. 1 is a schematic view of a supporting structure according to one embodiment of the invention;

FIG. 2 is a schematic view showing the rear structure of the supporting structure shown in FIG. 1;

FIG. 3 is a schematic view showing a support body and stoppers of the supporting structure shown in FIG. 1;

FIG. 4 is a view taken from direction A of FIG. 3;

FIG. 5 is a schematic view showing a structure of a stationary shaft of the supporting structure shown in FIG. 1;

FIG. 6 is a schematic view of a player according to one embodiment of the invention;

FIG. 7 is a view taken from direction B of FIG. 6; and

FIG. 8 is a schematic view of a movable device according to an embodiment of the invention.

### DETAILED DESCRIPTION

The present invention will be described in more details with reference to the drawings as follows.

### Example 1

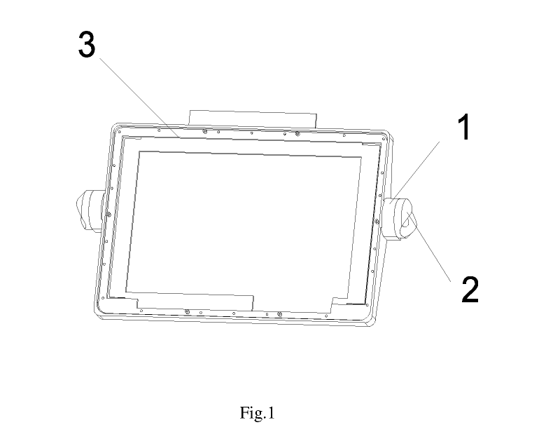

FIGS. 1 to 5 schematically show a supporting structure according to an embodiment of the present invention. As shown in FIG. 1, the supporting structure comprises stoppers 1, stationary shafts 2 and a support body 3.

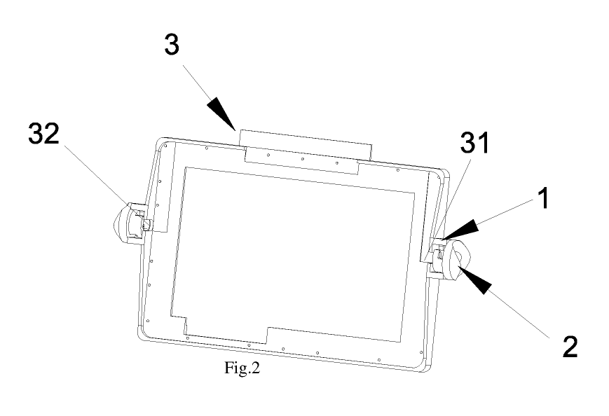

As shown in FIG. 2, the support body 3 may be formed as a rectangular frame. Support plates 31 are disposed at left and right sides of the support body 3 respectively. The support plates 31 are L-shaped. As shown in the drawings, each of the support plates 31 is fixedly connected at one end with the support body and the other end thereof passes through a side plate of the support body 3 through a groove 32 on the side plate. The support plate 31 on the left of the structure is not shown for the clarity purpose.

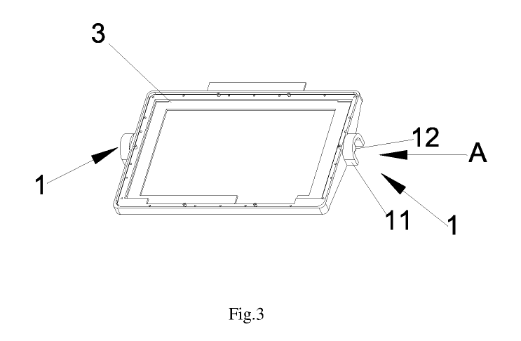

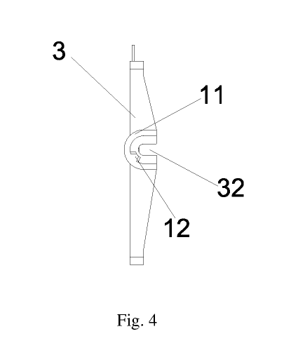

As shown in FIGS. 3 and 4, each of stoppers 1 comprises a stopper body 11 and a stopper projection 12. The stopper body 11 is U-shaped, and the stopper projection 12 is provided at the bottom of the inner wall of the stopper body 11. Two stoppers 1 are disposed on opposite sides of the support body 3 respectively. That is, two stopper bodies 11 of two stoppers 1 are fixedly connected to left and right side plates of the support body 3, respectively. Meanwhile, two stoppers 1 are disposed coaxially.

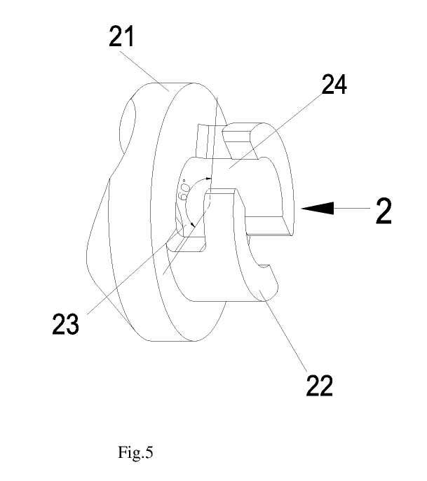

As shown in FIG. 5, each of the stationary shafts 2 comprises a shaft base 21 and a shaft portion 22 which are integrally connected with each other. The stationary shafts 2 are T-shaped along its longitudinal section. The shaft base 21 and the shaft portion 22 are formed to be cylindrical ers with a hollow structure. An arc-shaped notch 23 is disposed circumferentially at an end of the shaft portion connected to the shaft base. The arc-shaped notch 23 and the stopper projection 12 are matched in shape and size, so that the stoppers 1 can rotate about the stationary shafts 2 along the arc-shaped notch 23. The outer diameter of the shaft portion 22 is smaller (such as 0.5 mm) than the inner diameter of an arc portion at the bottom of the U-shaped stopper body, which can reduce the wear of the supporting structure and make the rotation of the stoppers around the stationary shaft 2 more efficient. A central angle of the arc-shaped notch 23 is an acute angle, so that a range of the rotational angle of the stoppers 1 around the stationary shafts 2 is 0°˜90°. For example, as shown in FIG. 5, the central angle of the curve notch 23 is 60°, thus the range of the rotational angle of the stoppers 1 is 60°. An opening 24 is formed at the other end of the shaft portion not connected to the shaft base 21 and is communicated with the arc-shaped notch 23, thereby facilitating the installation of the stoppers on the stationary shafts. The stationary shafts 2 may be disposed on a movable device and is coaxial with the stopper 1.

The stopper 1 is positioned corresponding to the groove 32 so that one end of the support plate 32 is inserted into the hollow portion of the interior of the stationary shaft 2 when the stopper 1 is coupled with the stationary shaft 2.

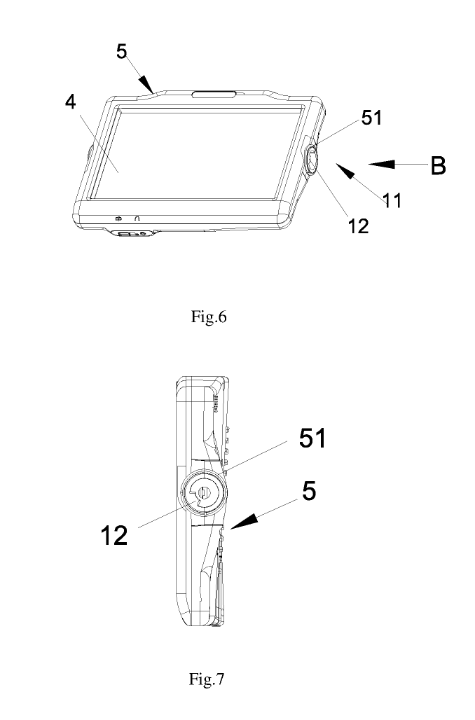

As shown in FIGS. 6 and 7, a player according to an embodiment of the invention comprises a supporting structure as described above, a player member 4 and a housing 5. The player member 4 comprises a conventional multimedia player, which is referred to as supported member. The player member 4 is disposed in the support body 3 of the supporting structure. The housing 5 is disposed outside the supporting structure. A hole is provided at a position where the housing 5 corresponds in position with the stopper 1 to accommodate the stopper and allow the installation of the stationary shaft.

A movable device comprising a movable device body and a player mentioned above will be described below. The stationary shafts of the supporting structure of the player are disposed on the movable device body. For illustrating and understanding purpose, trolley is described as an example of the movable device in the illustration of following embodiments. It will be understood for those skilled in the art that the embodiments of the invention will apply to any movable devices similar to the trolley.

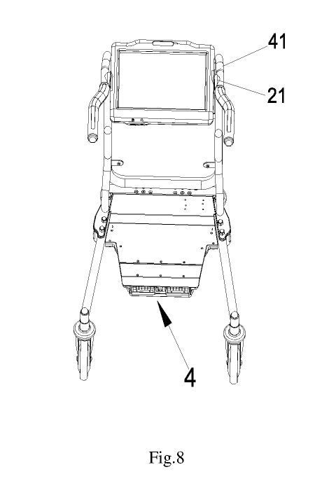

As shown in FIG. 8, the trolley comprises a trolley body 41 and a player mentioned above. The player is installed between the left and right frames of the trolley body 41, two shaft bodies 21 of the stationary shafts 2 on respective sides of the player are fixedly connected to the left and right frames of the trolley body 41 by welding or the like. Further, the player's stoppers 1 and the stationary shafts 2 are disposed coaxially, so that the player member 3 can rotate around the stationary shafts 2.

The above are merely some embodiments of the present invention. Those of ordinary skilled in the art will appreciate that various modifications and improvements can be made without departing from the concept and spirit of the present invention, and such modifications and improvements shall fall within the scope of the invention defined by the attached claims.

1-10. (canceled)

11. A supporting structure comprising:
a support body;
stationary shafts; and
stoppers disposed at opposite ends of the support body and on a same axis with the stationary shafts,
wherein each of the stationary shafts is provided with an arc-shaped notch matching with the stoppers circumferentially so that the stoppers are rotatable about the stationary shafts along the arc-shaped notch.

12. The supporting structure according to claim 11, wherein each of the stoppers includes a stopper body and a stopper projection provided on an inner wall of the stopper body.

13. The supporting structure according to claim 12, wherein said stopper body is U-shaped.

14. The supporting structure according to claim 13, wherein each of the stationary shafts includes a shaft base and a shaft portion which is in T-shaped connection with the shaft base, the arc-shaped notch being provided at an end of the shaft portion connected with the shaft base.

15. The supporting structure according to claim 14, wherein the shaft base and the shaft portion both have a hollow structure.

16. The supporting structure according to claim 11, wherein a central angle of the arc-shaped notch is an acute angle.

17. The supporting structure according to claim 15, wherein an outer diameter of the shaft portion is smaller than an inner diameter of an arc portion at the bottom of the stopper body.

18. The supporting structure according to claim 15, wherein the support plates are disposed on the support body, and an end of the support plates is inserted into the interior of the stationary shafts.

19. A player comprising a player member and the supporting structure of claim 11, wherein the player member comprises a multimedia player device and is disposed in the support body.

20. A movable device comprising a movable device body and the player of claim 19, wherein the stationary shafts of the supporting structure of the player are disposed on the movable device body.
